(19) United States
(12) Patent Application Publication
(10) Pub. No.: US 2025/0199484 A1
(43) Pub. Date: Jun. 19, 2025

(54) CONTROL PARAMETER ADJUSTMENT DEVICE AND CONTROL PARAMETER ADJUSTMENT METHOD

(71) Applicant: Panasonic Intellectual Property Management Co., Ltd., Osaka (JP)

(72) Inventors: Shun TAKAYANAGI, Osaka (JP); Naganori SHIRAKATA, Osaka (JP); Takayuki TSUKIZAWA, Osaka (JP); Takeshi ARAI, Osaka (JP); Taichi SATO, Kyoto (JP)

(21) Appl. No.: 18/847,539

(22) PCT Filed: Oct. 31, 2022
(86) PCT No.: PCT/JP2022/040783

§ 371 Date: Sep. 16, 2024

(30) Foreign Application Priority Data
Mar. 23, 2022 (JP) 2022-046512

(51) Int. Cl. G05B 13/02

(52) U.S. Cl. CPC G05B 13/024

(57) ABSTRACT

A control parameter adjustment device includes a first obtainer that obtains an adjustment target mechanical characteristic of an adjustment target apparatus; a second obtainer that obtains a plurality of mechanical characteristics and a plurality of adjustment histories respectively corresponding to a plurality of adjusted apparatuses; a control parameter adjuster that adjusts each of control parameters of an adjustment target servomotor with use of an optimization algorithm in which at least one of a search range or a search initial value of each of the control parameters is initially set, and outputs each of the control parameter adjusted; and an initial setter that initially sets at least one of the search range or the search initial value of each of the control parameters of the adjustment target servomotor into the optimization algorithm, based on the adjustment target mechanical characteristic, the plurality of mechanical characteristics, and the plurality of adjustment histories.

### TECHNICAL FIELD

The present disclosure relates to a control parameter adjustment device that adjusts a control parameter of a servomotor.

### BACKGROUND ART

Patent Literature (PTL) 1 describes a control parameter adjustment device that adjusts a control parameter of a servomotor.

### CITATION LIST

### Patent Literature

### [PTL 1]

Japanese Unexamined Patent Application Publication No. 2018-128832

### SUMMARY OF INVENTION

### Technical Problem

PTL 1, however, fails to disclose any specific method of determining an initial value by a parameter determiner. Therefore, adjusting a control parameter appropriately with the use of the conventional control parameter adjustment device described in PTL 1 requires that a skilled technical expert set an appropriate initial value.

Meanwhile, there exists a desire that anyone who is not even a skilled technical expert can adjust a control parameter appropriately.

Accordingly, the present disclosure is directed to providing a control parameter adjustment device and a control parameter adjustment method that each allow anyone who is not even a skilled technical expert can adjust a control parameter appropriately.

### Solution to Problem

A control parameter adjustment device according to one aspect of the present disclosure is a control parameter adjustment device that adjusts each of control parameters of an adjustment target servomotor included in an adjustment target apparatus, and the control parameter adjustment device includes: a first obtainer that obtains an adjustment target mechanical characteristic of the adjustment target apparatus; a second obtainer that obtains a plurality of mechanical characteristics and a plurality of adjustment histories respectively corresponding to a plurality of adjusted apparatuses each including an adjusted servomotor of which each of control parameters has been adjusted, the plurality of adjustment histories each being a history of adjusting each of the control parameters of the adjusted servomotor of a corresponding one of the adjusted apparatuses; a control parameter adjuster that adjusts each of the control parameters of the adjustment target servomotor with use of an optimization algorithm in which at least one of a search range or a search initial value of each of the control parameters of the adjustment target servomotor is initially set, and outputs each of the control parameters adjusted; and an initial setter that initially sets at least one of the search range or the search initial value of each of the control parameters of the adjustment target servomotor into the optimization algorithm, based on the adjustment target mechanical characteristic, the plurality of mechanical characteristics, and the plurality of adjustment histories.

A control parameter adjustment method according to one aspect of the present disclosure is a control parameter adjustment method of adjusting each of control parameters of an adjustment target servomotor included in an adjustment target apparatus, and the control parameter adjustment method includes: obtaining an adjustment target mechanical characteristic of the adjustment target apparatus; obtaining a plurality of mechanical characteristics and a plurality of adjustment histories respectively corresponding to a plurality of adjusted apparatuses each including an adjusted servomotor of which each of control parameters has been adjusted, the plurality of adjustment histories each being a history of adjusting each of the control parameters of the adjusted servomotor of a corresponding one of the adjusted apparatuses; adjusting each of the control parameters of the adjustment target servomotor with use of an optimization algorithm in which at least one of a search range or a search initial value of each of the control parameters of the adjustment target servomotor is initially set, and outputs each of the control parameters adjusted; and setting at least one of the search range or the search initial value of each of the control parameters of the adjustment target servomotor into the optimization algorithm, based on the adjustment target mechanical characteristic, the plurality of mechanical characteristics, and the plurality of adjustment histories.

### Advantageous Effects of Invention

The control parameter adjustment device and the control parameter adjustment method according to some aspects of the present disclosure allow anyone who is not even a skilled technical expert to adjust a control parameter appropriately.

### BRIEF DESCRIPTION OF DRAWINGS

FIG. 1 is a schematic diagram showing an overview of a control parameter adjustment system according to an embodiment.

FIG. 2 is a table mapping specific examples of an optimization algorithm according to an embodiment to their characteristics.

FIG. 3 is a schematic diagram for describing a settling time.

FIG. 4 shows one example of a frequency response that a resonance frequency calculator according to an embodiment calculates when it calculates a resonance frequency.

FIG. 5 is a schematic diagram showing how a database according to an embodiment stores a plurality of mechanical characteristics and a plurality of adjustment histories.

FIG. 6 is a flowchart of a control parameter adjusting process according to an embodiment.

FIG. 7 is a flowchart of a mechanical characteristic calculating process according to an embodiment.

FIG. 8 is a flowchart of an initial setting process according to an embodiment.

FIG. 9 is a schematic diagram showing one example of an image to be displayed on a display.

FIG. 10A is a schematic diagram showing one example of an image to be displayed on a display.

FIG. 10B is a schematic diagram showing another example of an image to be displayed on a display.

FIG. 11 is a schematic diagram showing how a calculator according to an embodiment calculates a first range and a second range.

FIG. 12 is a flowchart of an adjusting process according to an embodiment.

FIG. 13 is a flowchart of a storing process according to an embodiment.

### DESCRIPTION OF EMBODIMENTS

### (Underlying Knowledge Forming Basis of One Aspect of the Present Disclosure)

The inventors are developing a control parameter adjustment device that adjusts each of the control parameters of a servomotor included in an apparatus.

If the control parameter adjustment device disclosed in PTL 1 is used as such a control parameter adjustment device, as stated earlier, a skilled technical expert needs to set appropriate initial values in order to adjust the control parameters appropriately.

Thereupon, the inventors have diligently conducted a series of experiments and investigations in order to realize a control parameter adjustment device that allows anyone who is not even a skilled technical expert to adjust each of the control parameters of a servomotor included in an apparatus.

As a result, the inventors have found that (1) control parameters of a servomotor to be adjusted can be adjusted appropriately with the use of an optimization algorithm in which at least one of a search range or a search initial value of each of the control parameters is initially set appropriately and (2) an appropriate search range and an appropriate search initial value of each of the control parameters of the servomotor to be adjusted can be determined with the use of a mechanical characteristic of the apparatus of which the control parameters are to be adjusted, a mechanical characteristic of an apparatus of which the control parameters have been adjusted previously, and an adjustment history of the servomotor in the apparatus of which the control parameters have been adjusted previously.

Then, based on these findings, the inventors have further conducted a series of experiments and investigations. As a result, the inventors have come to conceive of the control parameter adjustment device and the control parameter adjustment method according to the present disclosure described below.

A control parameter adjustment device according to one aspect of the present disclosure is a control parameter adjustment device that adjusts each of control parameters of an adjustment target servomotor included in an adjustment target apparatus, and the control parameter adjustment device includes: a first obtainer that obtains an adjustment target mechanical characteristic of the adjustment target apparatus; a second obtainer that obtains a plurality of mechanical characteristics and a plurality of adjustment histories respectively corresponding to a plurality of adjusted apparatuses each including an adjusted servomotor of which each of control parameters has been adjusted, the plurality of adjustment histories each being a history of adjusting each of the control parameters of the adjusted servomotor of a corresponding one of the adjusted apparatuses; a control parameter adjuster that adjusts each of the control parameters of the adjustment target servomotor with use of an optimization algorithm in which at least one of a search range or a search initial value of each of the control parameters of the adjustment target servomotor is initially set, and outputs each of the control parameters adjusted; and an initial setter that initially sets at least one of the search range or the search initial value of each of the control parameters of the adjustment target servomotor into the optimization algorithm, based on the adjustment target mechanical characteristic, the plurality of mechanical characteristics, and the plurality of adjustment histories.

The control parameter adjustment device configured as described above makes it possible to adjust each of the control parameters of the adjustment target servomotor with the use of the optimization algorithm in which at least one of the search range or the search initial value of each of the control parameters of the adjustment target servomotor is initially set appropriately.

Accordingly, the control parameter adjustment device configured as described above makes it possible for anyone who is not even a skilled technical expert to adjust the control parameters appropriately.

Furthermore, the initial setter initially may set, into the optimization algorithm, both the search range and the search initial value of each of the control parameters of the adjustment target servomotor, and the control parameter adjuster may adjust each of the control parameters of the adjustment target servomotor with use of the optimization algorithm in which both the search range and the search initial value of each of the control parameters of the adjustment target servomotor are initially set.

This configuration makes it possible to adjust the control parameters with higher accuracy with the use of the optimization algorithm in which both the search range and the search initial value are initially set.

Furthermore, the adjustment target mechanical characteristic may include a resonance frequency of the adjustment target apparatus, the plurality of mechanical characteristics may each include a resonance frequency of a corresponding one of the plurality of adjusted apparatuses, the control parameter adjustment device may further include: an operation command outputter that outputs, to a driver that controls the adjustment target servomotor, an operation command that causes the adjustment target servomotor to operate; a third obtainer that obtains position information indicating a position of a driving target driven by the adjustment target servomotor that operates based on the operation command, by being controlled by the driver; and a resonance frequency calculator that calculates a resonance frequency of the adjustment target apparatus based on the position information, and outputs the adjustment target mechanical characteristic that includes the resonance frequency calculated, and the first obtainer may obtain the adjustment target mechanical characteristic calculated by the resonance frequency calculator.

This configuration makes it possible to adjust the control parameters with the use of the calculated resonance frequency of the adjustment target apparatus.

The control parameter adjustment device may further include: an outputter that outputs, to a database, the adjustment target mechanical characteristic output from the resonance frequency calculator and an adjustment history of adjusting each of the control parameters of the adjustment target servomotor by the control parameter adjuster, wherein the second obtainer may obtain the plurality of mechanical characteristics and the plurality of adjustment histories from the database.

This configuration makes it possible to use the mechanical characteristic and the adjustment history of the control target apparatus of which the control parameters have been adjusted previously as the mechanical characteristic and the adjustment history of the adjusted apparatus.

The control parameter adjustment device may further include: a calculator that calculates at least one of the search range or the search initial value of each of the control parameters of the adjustment target servomotor, based on the adjustment target mechanical characteristic, the plurality of mechanical characteristics, and the plurality of adjustment histories, wherein the initial setter may initially set, into the optimization algorithm, the at least one of the search range or the search initial value of each of the control parameters of the adjustment target servomotor, calculated by the calculator.

This configuration makes it possible for the user using the control parameter adjustment device configured as described above to adjust the control parameters without having determined at least one of the search range or the search initial value of each of the control parameters of the adjustment target servomotor.

Furthermore, when test control has been performed a plurality of times on the adjusted servomotor in a process of adjusting each of the control parameters of the adjusted servomotor, each of the plurality of adjustment histories may include, for each instance of the test control, (1) setting values of each of the control parameters of the adjusted servomotor and (2) evaluation values obtained by evaluating the test control, the control parameter adjustment device may further include: an extractor that extracts, from the plurality of mechanical characteristics, a first mechanical characteristic similar to the adjustment target mechanical characteristic; and an information calculator that, with regard to a first adjustment history, among the plurality of adjustment histories, of a first servomotor in a first adjusted apparatus having the first mechanical characteristic, calculates, for each of control parameters of the first servomotor, (1) the setting values, (2) setting frequency information pertaining to setting frequencies with which the setting values are set, and (3) evaluation value information pertaining to the evaluation values corresponding to the setting values, and the calculator may calculate at least one of the search range or the search initial value of each of the control parameters of the adjustment target servomotor, based on the setting values, the setting frequency information, and the evaluation value information calculated by the information calculator.

This configuration makes it possible to adjust the control parameters with the use of the calculated setting values, the calculated setting frequency information, and the calculated evaluation value information.

The control parameter adjustment device may further include: a presenter that presents, to a user of the control parameter adjustment device, at least part of the adjustment target mechanical characteristic, the plurality of mechanical characteristics, and the plurality of adjustment histories; and an input receiver that, after the presenting by the presenter, receives, from the user, input of at least one of the search range or the search initial value of each of the control parameters of the adjustment target servomotor, wherein the initial setter may initially set, into the optimization algorithm, the at least one of the search range or the search initial value of each of the control parameters of the adjustment target servomotor, received by the input receiver.

The user using the control parameter adjustment device configured as described above can determine at least one of the appropriate search range or the appropriate search initial value based on the at least part presented of the adjustment target mechanical characteristic, the plurality of mechanical characteristics, and the plurality of adjustment histories.

Accordingly, the control parameter adjustment device configured as described above makes it possible to adjust each of the control parameters of the adjustment target servomotor with the use of the at least one, determined by the user, of the appropriate search range and the appropriate search initial value.

Furthermore, when test control has been performed a plurality of times on the adjusted servomotor in a process of adjusting each of the control parameters of the adjusted servomotor, each of the plurality of adjustment histories may include, for each instance of the test control, (1) setting values of each of the control parameters of the adjusted servomotor and (2) evaluation values obtained by evaluating the test control, the control parameter adjustment device may further include: an extractor that extracts, from the plurality of mechanical characteristics, a first mechanical characteristic similar to the adjustment target mechanical characteristic; and an information calculator that, with regard to a first adjustment history, among the plurality of adjustment histories, of a first servomotor in a first adjusted apparatus having the first mechanical characteristic, calculates, for each of control parameters of the first servomotor, (1) the setting values, (2) setting frequency information pertaining to setting frequencies with which the setting values are set, and (3) evaluation value information pertaining to the evaluation values corresponding to the setting values, and the presenter may present the at least part to the user based on the setting values, the setting frequency information, and the evaluation value information calculated by the information calculator.

This configuration makes it possible for the user using the control parameter adjustment device configured as described above to determine at least one of an even more appropriate search range or an even more appropriate search initial value based on the at least part presented based on the setting values, the setting frequency information, and the evaluation value information.

A control parameter adjustment method according to one aspect of the present disclosure is a control parameter adjustment method of adjusting each of control parameters of an adjustment target servomotor included in an adjustment target apparatus, and the control parameter adjustment method includes: obtaining an adjustment target mechanical characteristic of the adjustment target apparatus; obtaining a plurality of mechanical characteristics and a plurality of adjustment histories respectively corresponding to a plurality of adjusted apparatuses each including an adjusted servomotor of which each of control parameters has been adjusted, the plurality of adjustment histories each being a history of adjusting each of the control parameters of the adjusted servomotor of a corresponding one of the adjusted apparatuses; adjusting each of the control parameters of the adjustment target servomotor with use of an optimization algorithm in which at least one of a search range or a search initial value of each of the control parameters of the adjustment target servomotor is initially set, and outputs each of the control parameters adjusted; and setting at least one of the search range or the search initial value of each of the control parameters of the adjustment target servomotor into the optimization algorithm, based on the adjustment target mechanical characteristic, the plurality of mechanical characteristics, and the plurality of adjustment histories.

The control parameter adjustment method of the above makes it possible to adjust each of the control parameters of the adjustment target servomotor with the use of the optimization algorithm in which at least one of the search range or the search initial value of each of the control parameters of the adjustment target servomotor is initially set appropriately.

Accordingly, the control parameter adjustment method of the above makes it possible for anyone who is not even a skilled technical expert to adjust the control parameters appropriately.

Hereinafter, some specific examples of a control parameter adjustment system according to one aspect of the present disclosure will be described with reference to the drawings. The embodiments described herein merely illustrate some specific examples of the present disclosure. Therefore, the numerical values, the shapes, the constituent elements, the arrangement and the connection modes of the constituent elements, the steps, the order of the steps, and so on illustrated in the following embodiments are examples and are not intended to limit the present disclosure. Moreover, the drawings are schematic diagrams and do not necessarily provide exact depictions. In the drawings, substantially identical components are given identical reference characters, and duplicate description thereof will be omitted or simplified.

### Embodiment 1

### <Configuration>

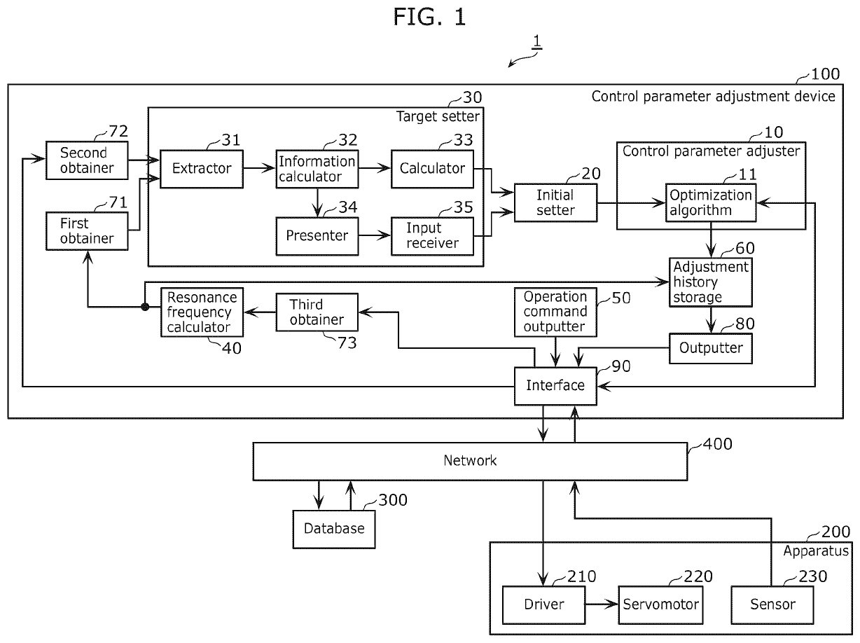

FIG. 1 is a block diagram showing a configuration of control parameter adjustment system 1 according to an embodiment.

As shown in FIG. 1, control parameter adjustment system 1 includes control parameter adjustment device 100, apparatus 200, database 300, and network 400.

Apparatus 200 is connected to network 400. Apparatus 200 includes driver 210, servomotor 220, and sensor 230.

Apparatus 200 is an apparatus used, for example, to produce devices and, for example, processes, mounts, or transport devices. Apparatus 200 is installed, for example, in a production line at a factory. Some specific examples of apparatus 200 include an LED die bonder, a mounting apparatus, a processing apparatus, and an extraction robot.

Driver 210 stores a control parameter or control parameters for controlling servomotor 220. Driver 210, in response to receiving, via network 400, an operation command defining an operation of servomotor 220, controls servomotor 220 using a stored control parameter so as to cause servomotor 220 to perform the operation defined by the received operation command.

An operation command may be, for example but is not limited to, a position command, a speed command, or an acceleration command.

Control parameters include, for example, a plurality of parameters such as a parameter defining a gain, a parameter defining a cutoff frequency, and a parameter defining a filter type. In this example, there are 50 control parameters, and each of these control parameters can have around 100 different levels of possible settings.

Servomotor 220 has its operation controlled by driver 210 and drives a driving target. Some examples of a driving target include a processing target to be processed in apparatus 200, a mounting target to be mounted by apparatus 200, and a transportation target to be transported by apparatus 200.

Servomotor 220 may be, for example but is not limited to, a rotary motor or a linear motor.

Sensor 230 detects the state of a driving target and outputs sensor information indicating the detected state of the driving target. The state of a driving target may be, for example but is not limited to, the position of the driving target, the speed of the driving target, or the acceleration of the driving target. In the description provided herein, sensor 230 successively detects the position of a driving target and outputs position information indicating the successively detected positions of the driving target to control parameter adjustment device 100. In other words, in the description below, sensor information that sensor 230 outputs is also referred to as position information.

Database 300 is connected to network 400. Database 300 stores various items of information that control parameter adjustment device 100 uses.

In the description provided herein, database 300 is external to control parameter adjustment device 100. Alternatively, control parameter adjustment device 100, for example, may include database 300.

Network 400 is connected to control parameter adjustment device 100, apparatus 200, and database 300 and transmits signals exchanged between the connected entities. Network 400 may be, for example but is not limited to, the internet or a local area network (LAN).

In the description provided herein, network 400 transmits signals exchanged between control parameter adjustment device 100, apparatus 200, and database 300. Alternatively, control parameter adjustment device 100, apparatus 200, and database 300 may be connected to each other, for example, without involving network 400 and may directly exchange signals therebetween.

Control parameter adjustment device 100 is connected to network 400. Control parameter adjustment device 100 includes control parameter adjuster 10, initial setter 20, target setter 30, resonance frequency calculator 40, operation command outputter 50, adjustment history storage 60, first obtainer 71, second obtainer 72, third obtainer 73, outputter 80, and interface 90.

Control parameter adjustment device 100 is a device that adjusts each of the control parameters of servomotor 220 included in apparatus 200. Control parameter adjustment device 100 is realized, for example, as, in a computer device that includes a processor (not shown), a memory (not shown), and various input and output interfaces (not shown), the processor executes a program stored in the memory.

Interface 90 is connected to network 400, control parameter adjuster 10, operation command outputter 50, second obtainer 72, third obtainer 73, and outputter 80 and relays signals exchanged between network 400 and each of the connected blocks in control parameter adjustment device 100.

Control parameter adjuster 10 holds therein optimization algorithm 11. As will be described later, optimization algorithm 11 has initially set therein by initial setter 20 at least one of a search range or a search initial value of each of the control parameters of servomotor 220. Control parameter adjuster 10, by using optimization algorithm 11 having initially set therein at least one of the search range or the search initial value of each of the control parameters of servomotor 220, adjusts each of the control parameters of servomotor 220 and outputs each of the adjusted control parameters. Each of the adjusted control parameters output from control parameter adjuster 10 is obtained by driver 210, and having obtained each of the adjusted control parameters, driver 210 overwrites each of the control parameters stored therein.

Specifically, optimization algorithm 11 may be, for example but is not limited to, a Bayesian optimization algorithm, an evolution strategy algorithm, or a genetic algorithm.

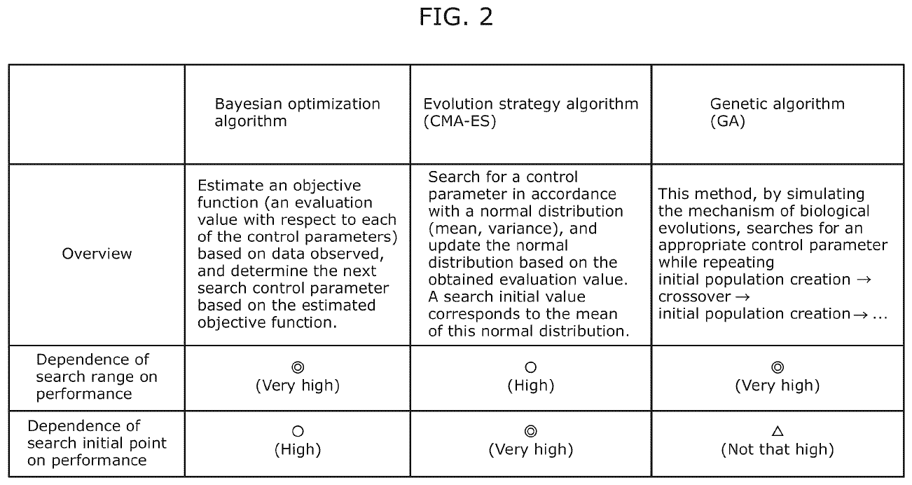

FIG. 2 is a table mapping the specific examples of optimization algorithm 11 to their characteristics.

When optimization algorithm 11 is, for example, a genetic algorithm, control parameter adjuster 10 may adjust each of the control parameters of servomotor 220 with the use of optimization algorithm 11 in which the search range of each of the control parameters of servomotor 220 is initially set by initial setter 20.

Meanwhile, when optimization algorithm 11 is, for example, a Bayesian optimization algorithm, control parameter adjuster 10 may adjust each of the control parameters of servomotor 220 with the use of optimization algorithm 11 in which both the search range and the search initial value of each of the control parameters of servomotor 220 are initially set by initial setter 20.

Meanwhile, when optimization algorithm 11 is, for example, an evolution strategy algorithm, control parameter adjuster 10 may adjust each of the control parameters of servomotor 220 with the use of optimization algorithm 11 in which both the search range and the search initial value of each of the control parameters of servomotor 220 are initially set by initial setter 20.

Referring back to FIG. 1, control parameter adjustment system 1 will be further described.

Control parameter adjuster 10, for example, test controls servomotor 220 a plurality of times while varying the value of each of the control parameters of servomotor 220 with the use of driver 210, and calculates the evaluation value of each of the plurality of instances of test control. Control parameter adjuster 10 adjusts the control parameters of servomotor 220 each time control parameter adjuster 10 test controls servomotor 220 based on the calculated evaluation value.

In the description provided herein, control parameter adjuster 10 calculates, as the evaluation value, the settling time for each of the plurality of instances of test control and adjusts the control parameters of servomotor 220 so as to reduce the settling time to be calculated, that is, so as to reduce the evaluation value.

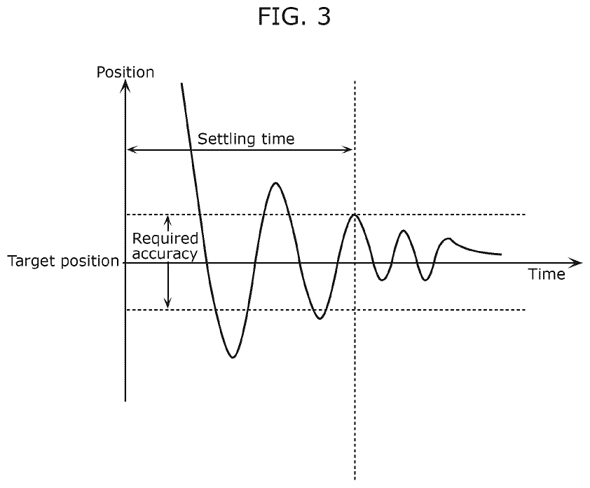

FIG. 3 is a schematic diagram for describing a settling time.

In FIG. 3, the horizontal axis represents the time that has elapsed from the start of the test control, and the vertical axis represents the position of the driving target detected by sensor 230.

In this example, as shown in FIG. 3, the settling time refers to the length of time from the time when test control is started to the time when the position of the driving target becomes contained within a required accuracy that is based on the target position.

Referring back to FIG. 1, control parameter adjustment system 1 will be further described.

Operation command outputter 50 outputs to driver 210 an operation command that causes servomotor 220 to operate.

Third obtainer 73 obtains position information that is output from sensor 230, that is, the position information that indicates the position of the driving target driven by servomotor 220 that operates under the control of driver 210 and based on the operation command output from operation command outputter 50.

Resonance frequency calculator 40 calculates the resonance frequency of apparatus 200 based on the position information obtained by third obtainer 73 and outputs a mechanical characteristic, including the calculated resonance frequency, of apparatus 200. In the description provided herein, resonance frequency calculator 40 outputs the calculated resonance frequency as a mechanical characteristic of apparatus 200.

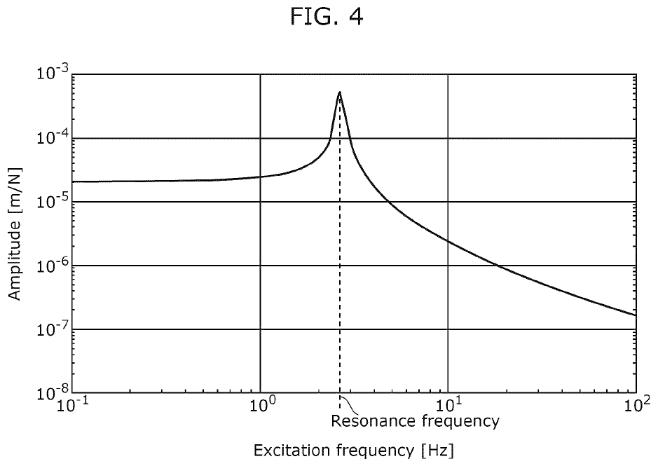

FIG. 4 shows one example of a frequency response that resonance frequency calculator 40 calculates when it calculates the resonance frequency.

In FIG. 4, the horizontal axis represents the excitation frequency in apparatus 200, and the vertical axis represents the amplitude (the gain).

As shown in FIG. 4, resonance frequency calculator 40 calculates the frequency response of apparatus 200 based, for example, on the position information obtained by third obtainer 73. Resonance frequency calculator 40 then calculates, as the resonance frequency, the excitation frequency at the peak of the amplitude (the gain) in the calculated frequency response.

Referring back to FIG. 1, control parameter adjustment system 1 will be further described.

First obtainer 71 obtains the mechanical characteristic of apparatus 200 calculated by resonance frequency calculator 40.

Second obtainer 72 obtains from database 300 a plurality of mechanical characteristics and a plurality of adjustment histories respectively corresponding to a plurality of apparatuses each including a servomotor of which the control parameters have been adjusted previously. In the description provided herein, the plurality of mechanical characteristics respectively corresponding to the plurality of apparatuses are the plurality of resonance frequencies respectively corresponding to the plurality of apparatuses.

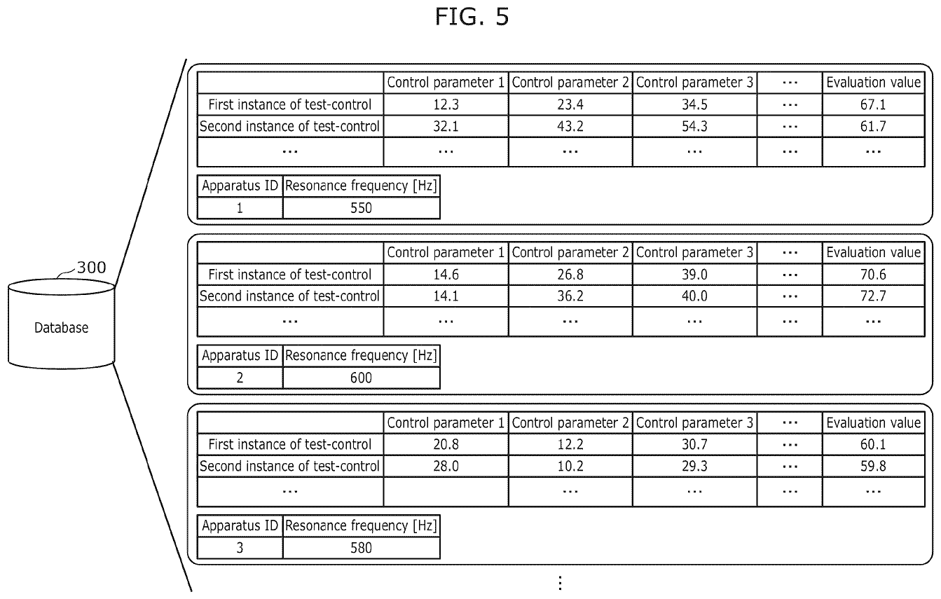

FIG. 5 is a schematic diagram showing how database 300 stores a plurality of mechanical characteristics and a plurality of adjustment histories respectively corresponding to a plurality of apparatuses.

As shown in FIG. 5, database 300 stores therein, for each of a plurality of apparatuses, the mechanical characteristic served by the resonance frequency of the apparatus and the adjustment history of the control parameters adjusted previously of the servomotor in that apparatus, with the mechanical characteristic and the adjustment history mapped to each other.

Furthermore, as shown in FIG. 5, each entry of the adjustment history maps to each other the setting value and the evaluation value of the control parameter obtained in given test control, among a plurality of instances of test control performed to test control the servomotor in the process of adjusting the control parameters.

Referring back to FIG. 1, control parameter adjustment system 1 will be further described.

Target setter 30 includes extractor 31, information calculator 32, calculator 33, presenter 34, and input receiver 35.

Extractor 31 extracts, from the plurality of mechanical characteristics obtained by second obtainer 72, a first mechanical characteristic that is similar to the mechanical characteristic of apparatus 200 obtained by first obtainer 71. To be more specific, extractor 31 extracts, from the plurality of mechanical characteristics obtained by second obtainer 72, the mechanical characteristic composed of a resonance frequency similar to the resonance frequency of apparatus 200 as the first mechanical characteristic.

Extractor 31 may extract, for example, a mechanical characteristic composed of the resonance frequency that is the most similar to the resonance frequency of apparatus 200 as one first mechanical characteristic, or may extract, for example, five mechanical characteristics composed of the resonance frequencies that are the most to the fifth most similar to the resonance frequency of apparatus 200 as five first mechanical characteristics.

Information calculator 32 calculates, for each of the first mechanical characteristics among the plurality of mechanical characteristics obtained by second obtainer 72, the setting value, the setting frequency information pertaining to the setting frequency of the setting value, and the evaluation value information pertaining to the evaluation value corresponding to the setting value for each of the control parameters of a first servomotor with respect to a first adjustment history of the first servomotor included in a first apparatus having the first mechanical characteristic.

In the description provided herein, information calculator 32 calculates, for each of the control parameters of the first servomotor, each of the one or more setting values included in the first adjustment history as the setting value mentioned above, calculates the frequency with which the setting value has been set as the setting frequency mentioned above, and calculates the mean value of the evaluation values obtained when the setting values are set as the evaluation value information mentioned above.

Calculator 33 calculates at least one of a search range or a search initial value of each of the control parameters of servomotor 220 based on the plurality of mechanical characteristics and the plurality of adjustment histories obtained by second obtainer 72. To be more specific, calculator 33 calculates at least one of the search range or the search initial value of each of the control parameters of servomotor 220 based on the setting value, the setting frequency information, and the evaluation value information calculated by information calculator 32 with respect to one first mechanical characteristic composed of the resonance frequency that is the most similar to the resonance frequency of apparatus 200.

In the description provided herein, calculator 33 calculates, as the search range, a range shared by a first range that includes the setting value corresponding to the setting frequency whose value is in the top X % (X is a value greater than 0 but no greater than 100) among the setting frequencies indicated by the setting frequency information and a second range that includes the setting value corresponding to the mean value of the setting values falling below a predetermined value among the mean values of the evaluation values indicated by the evaluation value information.

Furthermore, in the description provided herein, calculator 33 calculates, as the search initial value, the setting value corresponding to the lowest mean value of the evaluation values among the mean values of the evaluation values indicated by the evaluation value information.

Presenter 34 presents to the user of control parameter adjustment device 100 at least part of the mechanical characteristic of apparatus 200 obtained by first obtainer 71, the plurality of mechanical characteristics obtained by second obtainer 72, and the plurality of adjustment histories obtained by second obtainer 72. To be more specific, presenter 34 presents to the user the at least part mentioned above based on the setting value, the setting frequency information, and the evaluation value information calculated by information calculator 32.

Presenter 34 includes, for example, a display and displays the at least part to the user by displaying on the display at least part of the setting value, the setting frequency information, and the evaluation value information calculated by information calculator 32.

Input receiver 35, after presenter 34 has presented the information mentioned above, receives from the user an input of at least one of the search range or the search initial value of each of the control parameters of servomotor 220.

Target setter 30 outputs to initial setter 20 either one of at least one of the search range or the search initial value of each of the control parameters of servomotor 220 calculated by calculator 33 (also referred to below as a first at least one) and at least one of the search range or the search initial value of each of the control parameters of servomotor 220 received by input receiver 35 (also referred to below as a second at least one).

Target setter 30 may output, for example, the one of the first at least one and the second at least one that is specified by the user.

Initial setter 20 initially sets in optimization algorithm 11 at least one of the search range or the search initial value of each of the control parameters of servomotor 220 output from target setter 30.

Adjustment history storage 60 stores an adjustment history obtained when control parameter adjuster 10 adjusts each of the control parameters of servomotor 220. To be more specific, adjustment history storage 60 stores an adjustment history that maps to each other the setting value and the evaluation value of each of the control parameters obtained in each instance of test control when the servomotor is test controlled a plurality of times in the process of adjusting each of the control parameters.

Outputter 80 outputs to database 300 the mechanical characteristic of apparatus 200 output from resonance frequency calculator 40 and the adjustment history stored in adjustment history storage 60, that is, the adjustment history obtained when control parameter adjuster 10 has adjusted each of the control parameters of servomotor 220. Then, database 300 stores the mechanical characteristic of apparatus 200 and the adjustment history obtained when control parameter adjuster 10 has adjusted each of the control parameters of servomotor 220 output from outputter 80, with the mechanical characteristic and the adjustment history mapped to each other.

### <Operation >

Now, an operation performed by control parameter adjustment system 1 configured as described above will be described.

Control parameter adjustment system 1 executes a control parameter adjusting process of adjusting each of the control parameters stored by driver 210 to an appropriate value and of updating each of the control parameters stored by driver 210 with the adjusted value. The control parameter adjusting process is started as, for example, the user using control parameter adjustment system 1 operates control parameter adjustment device 100 to start the control parameter adjusting process.

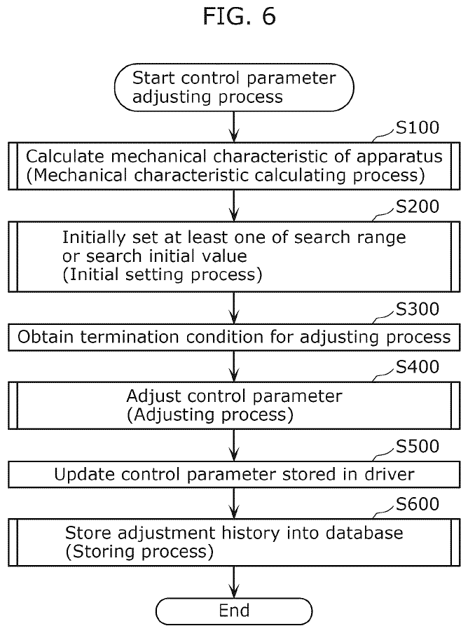

FIG. 6 is a flowchart of a control parameter adjusting process.

As shown in FIG. 6, upon the start of the control parameter adjusting process, control parameter adjustment device 100 executes a mechanical characteristic calculating process of calculating the mechanical characteristic of apparatus 200 (step S100).

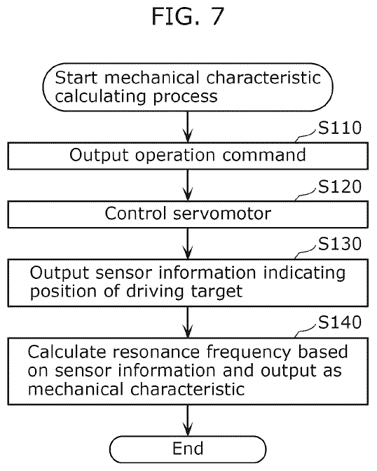

FIG. 7 is a flowchart of the mechanical characteristic calculating process.

As shown in FIG. 7, upon the start of the mechanical characteristic calculating process, operation command outputter 50 outputs an operation command to driver 210 to cause servomotor 220 to perform a predetermined operation (step S110).

Driver 210 then receives the operation command and, with the use of the stored control parameters, controls servomotor 220 so as to cause servomotor 220 to perform the operation defined by the received operation command (step S120).

In response to servomotor 220 performing the operation defined by the operation command under the control of driver 210, the driving target is driven by servomotor 220 that performs that operation.

Sensor 230 successively detects the position of the driving target during the period in which the driving target is being driven by servomotor 220 that performs the operation defined by the operation command, and outputs the position information indicating the successively detected positions of the driving target to control parameter adjustment device 100 (step S130).

Upon the position information being output from sensor 230, third obtainer 73 obtains the position information output from sensor 230. Then, based on the position information obtained by third obtainer 73, resonance frequency calculator 40 calculates the resonance frequency of apparatus 200 and outputs the calculated resonance frequency as the mechanical characteristic of apparatus 200 (step S140).

When the process at step S140 ends, control parameter adjustment device 100 terminates this instance of mechanical characteristic calculating process.

Referring back to FIG. 6, the control parameter adjusting process will be further described.

When the mechanical characteristic calculating process at step S100 ends, control parameter adjustment device 100 executes an initial setting process of initially setting at least one of a search range or a search initial value of each of the control parameters of servomotor 220 into optimization algorithm 11 (step S200).

In the description provided herein, both the search range and the search initial value of each of the control parameters of servomotor 220 are initially set in the initial setting process. However, as long as the initial setting process is the process of initially setting at least one of the search range or the search initial value of each of the control parameters of servomotor 220, the initial setting process does not need to be limited to the process of initially setting both the search range and the search initial value of each of the control parameters of servomotor 220.

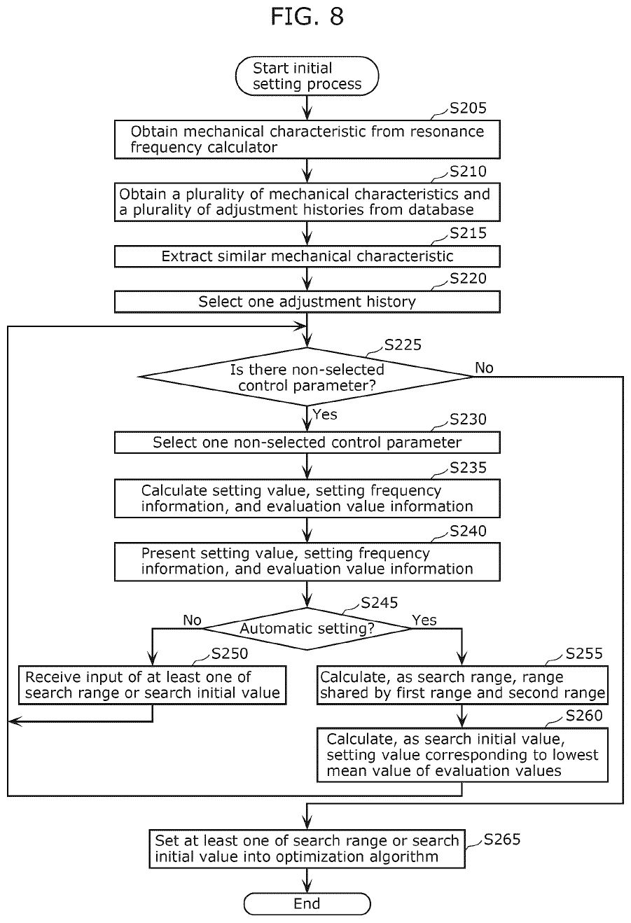

FIG. 8 is a flowchart of an initial setting process.

As shown in FIG. 8, upon the start of the initial setting process, first obtainer 71 obtains from resonance frequency calculator 40 the calculated mechanical characteristic of apparatus 200 (step S205).

Then, second obtainer 72 obtains from database 300 a plurality of mechanical characteristics and a plurality of adjustment histories respectively corresponding to a plurality of apparatuses each including a servomotor of which the control parameters have been adjusted previously (step S210).

Then, extractor 31 extracts, from the plurality of mechanical characteristics obtained by second obtainer 72, a first mechanical characteristic that is similar to the mechanical characteristic of apparatus 200 obtained by first obtainer 71 (step S215).

In the description provided herein, extractor 31 extracts five mechanical characteristics composed of the resonance frequencies that are the most to the fifth most similar to the resonance frequency of apparatus 200 as five first mechanical characteristics.

Information calculator 32 then selects one adjustment history from among the five adjustment histories corresponding to the respective five first mechanical characteristics (step S220).

Information calculator 32 may, for example, select, from among the five first mechanical characteristics, an adjustment history corresponding to the one of the first mechanical characteristics that is specified by the user as the one adjustment history, or may, for example, select one adjustment history corresponding to the mechanical characteristic composed of the resonance frequency that is the most similar to the resonance frequency of apparatus 200, regardless of the specification by the user.

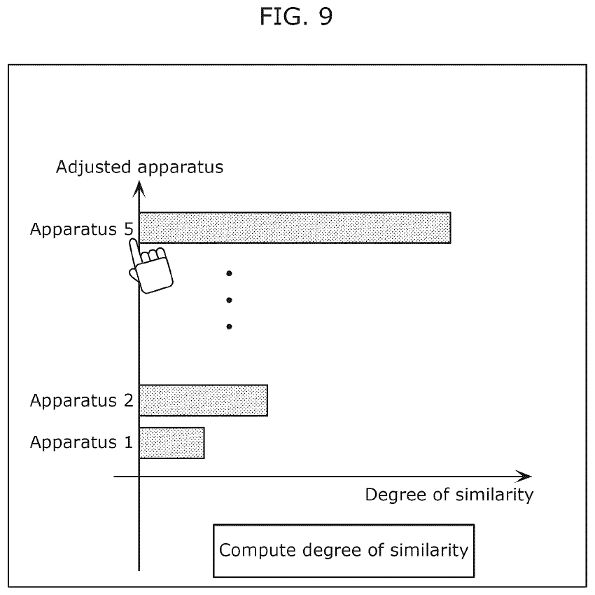

FIG. 9 is a schematic diagram showing one example of an image to be presented to the user, that is, one example of an image to be displayed on the display when the user is allowed to specify one mechanical characteristic from among N first mechanical characteristics (N is 5 in this example).

In FIG. 9, the horizontal axis represents the degree of similarity indicating the degree to which the resonance frequency in the first mechanical characteristic is similar to the resonance frequency of apparatus 200. In this example, the degree of similarity takes a greater value as the difference between the resonance frequency in the target mechanical characteristic and the resonance frequency of apparatus 200 is smaller.

As shown in FIG. 9, the user specifies, for example, the adjustment history of apparatus 5 corresponding to the first mechanical characteristic having the highest degree of similarity as the one adjustment history to be selected by information calculator 32.

Referring back to FIG. 8, the initial setting process will be further described.

In response to one adjustment history being selected in the process at step S220, information calculator 32 determines whether there is a non-selected control parameter in the selected adjustment history (step S225).

In this example, a non-selected control parameter is a control parameter that has never been selected in the process at step S230 executed previously in the loop processing including the process at step S225 and the process at step S230 described later.

If it is determined in the process at step S225 that there is a non-selected control parameter (step S225: Yes), information calculator 32 selects one non-selected control parameter (step S230).

Upon selecting the one non-selected control parameter, information calculator 32 calculates the setting value, the setting frequency information, and the evaluation value information of the selected control parameter (step S235). Then, presenter 34 displays on the display the setting value, the setting frequency information, and the evaluation value information calculated by information calculator 32 to thus present these items of information to the user (step S240).

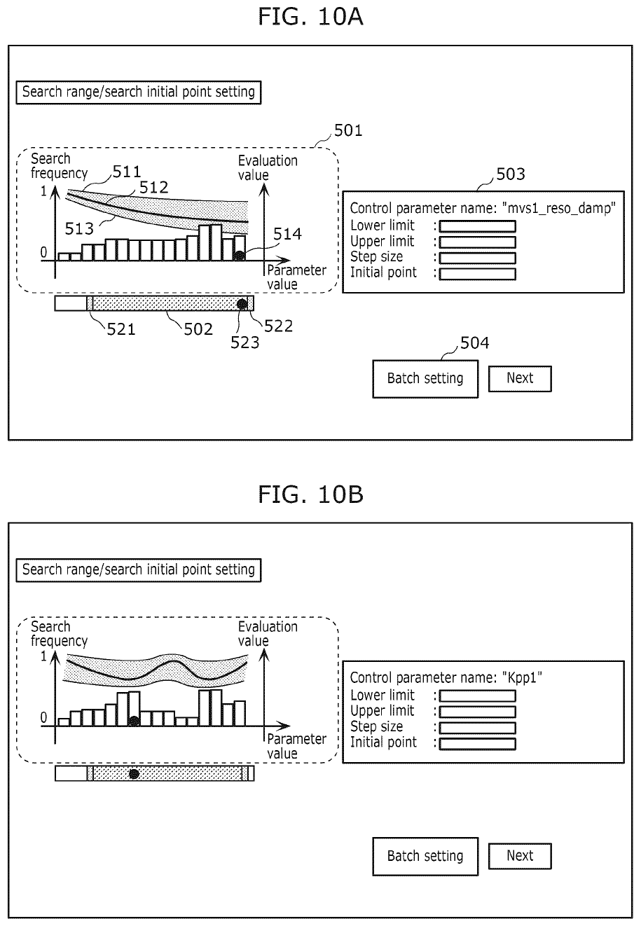

FIG. 10A is a schematic diagram showing one example of an image that presenter 34 displays on the display in the process at step S235.

FIG. 10B is a schematic diagram showing another example of an image that presenter 34 displays on the display in the process at step S235.

As shown in FIG. 10A, an image that presenter 34 displays on the display includes graph 501, slide bar 502, control parameter information 503, and automatic setting icon 504.

In graph 501, the horizontal axis represents the setting value (the parameter value) to which the control parameter has been set in test control executed a plurality of times, vertical axis 1 (the vertical axis on the left side) represents the frequency with which the control parameter has been set to the corresponding setting value, and vertical axis 2 (the vertical axis on the right side) represents the evaluation value obtained when the control parameter has been set to the corresponding setting value.

In the description provided herein, vertical axis 1 represents the frequency with which the control parameter has been set to the corresponding setting value. Alternatively, it suffices that vertical axis 1 represent a numerical value indicating the frequency with which the control parameter has been set to the corresponding setting value, and such a numerical value may be, for example, the number of times that the control parameter has been set to the corresponding setting value.

In graph 501, the set of vertical bars is a histogram of the setting values to which the control parameters have been set, with vertical axis 1 serving as the vertical axis.

In graph 501, with vertical axis 2 being the vertical axis, the lines show, with respect to the setting values to which the control parameters have been set, (1) the upper limit values of the evaluation values (line 511 at the top), (2) the mean values of the evaluation values (line 512 in the middle), and (3) the lower limit values of the evaluation values (line 513 at the bottom).

In graph 501, solid circle 514 is a mark indicating the setting value at which the mean value of the evaluation values takes the smallest value.

The user sees graph 501. Based on the displayed contents of graph 501 that the user has seen, the user then, by operating slide bar 502, can input at least one of the search range or the search initial value of the control parameter being displayed.

Specifically, the user can input the lower limit value of the search range by sliding first slide axis 521 to right and left and can input the upper limit value of the search range by sliding second slide axis 522 to right and left. Furthermore, the user can input the search initial value by sliding solid circle 523 to right and left.

Moreover, the user can cause calculator 33 to calculate at least one of the search range or the search initial value of all the control parameters (in the description provided herein, calculator 33 calculates both the search range and the search initial value of all the control parameters) by clicking automatic setting icon 504.

Referring back to FIG. 8, the initial setting process will be further described.

Upon the setting value, the setting frequency information, and the evaluation value information being presented in the process at step S240, presenter 34 determines whether the user has performed an operation of causing calculator 33 to calculate the search range and the search initial value of all the control parameters (step S245). Specifically, presenter 34 determines whether the user has clicked automatic setting icon 504 previously.

If it is determined in the process at step S245 that the operation of causing calculator 33 to calculate the search range and the search initial value of all the parameters is not performed (step S245: No), input receiver 35 receives input from the user of at least one of the search range or the search initial value (step S250). In the description provided herein, input receiver 35 receives input from the user of both the search range and the search initial value.

If it is determined in the process at step S245 that the operation of causing calculator 33 to calculate the search range and the search initial value of all the control parameters has been performed (step S245: Yes), calculator 33 calculates the range shared by the first range and the second range as the search range (step S255).

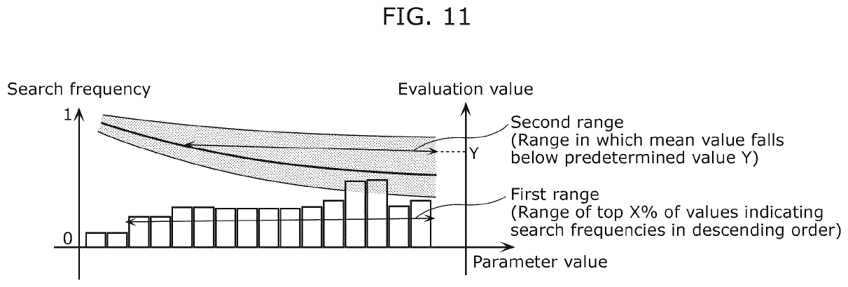

FIG. 11 is a schematic diagram showing how calculator 33 calculates the first range and the second range in the process at step S255.

As shown in FIG. 11, calculator 33 calculates, as the first range, the range that includes the setting values corresponding to the setting frequencies in the top X % of the values indicating the setting frequencies in descending order and calculates, as the second range, the range that includes the setting values corresponding to the mean values of the evaluation values falling below a predetermined value.

Referring back to FIG. 8, the initial setting process will be further described.

Upon the search range being calculated in the process at step S255, calculator 33 calculates the setting value corresponding to the lowest mean value of the evaluation values as the search initial value (step S260).

When the process at step S250 ends or when the process at step S260 ends, the initial setting process returns to the process at step S225.

If it is determined in the process at step S225 that there is no non-selected control parameter (step S225: No), initial setter 20 initially sets at least one of the search range or the search initial value of each of the control parameters of servomotor 220 (step S265).

When the process at step S265 ends, control parameter adjustment device 100 terminates this instance of initial setting process.

Referring back to FIG. 6, the control parameter adjusting process will be further described.

When the initial setting process at step S200 ends, control parameter adjuster 10 obtains a termination condition for terminating the adjusting process (step S300).

The termination condition may be, for example but is not limited to, the upper limit of the number of times the test control executed in the adjusting process is executed, the upper limit of the execution duration in which the adjusting process is executed, or the target value that the evaluation value calculated in the test control is to achieve.

Upon the termination condition for terminating the adjusting process being obtained, control parameter adjustment device 100 executes an adjusting process of adjusting each of the control parameters that driver 210 stores to an appropriate value (step S400).

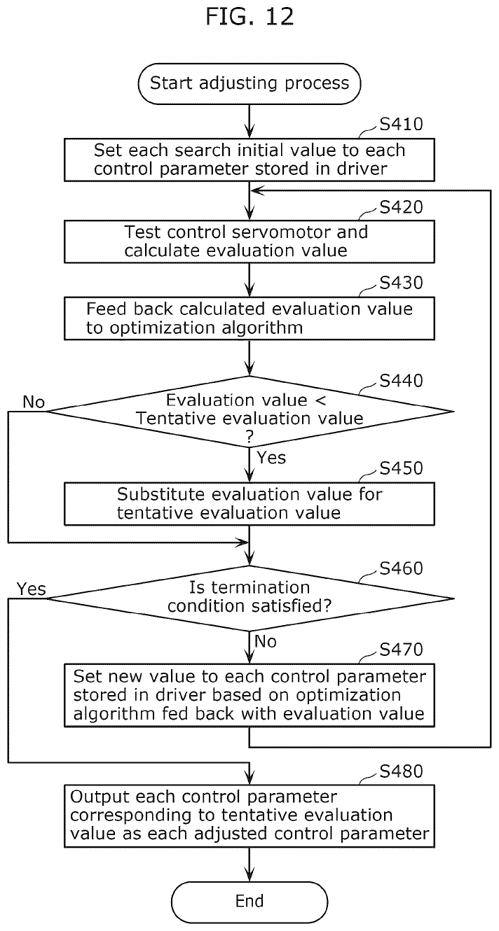

FIG. 12 is a flowchart of an adjusting process.

As shown in FIG. 12, upon the start of the adjusting process, control parameter adjuster 10 sets, into each of the control parameters that driver 210 stores, each of the search initial values of the control parameters set initially in optimization algorithm 11 in the process at step S265 (step S410).

In response to each of the control parameters being set, control parameter adjuster 10 test controls servomotor 220 to calculate the evaluation value (step S420).

Upon calculating the evaluation value, control parameter adjuster 10 feeds back the calculated evaluation value to optimization algorithm 11 (step S430).

Control parameter adjuster 10 then determines whether the calculated evaluation value is smaller than a tentative evaluation value (step S440).

In this example, a tentative evaluation value is an evaluation value substituted in the process at step S450 executed previously in the loop processing including the process at step S440 and the process at step S450 described later. The initial value of the tentative evaluation value is, for example, the maximum value that the evaluation value can take.

If it is determined in the process at step S440 that the calculated evaluation value is smaller than the tentative evaluation value (step S440: Yes), control parameter adjuster 10 substitutes the calculated evaluation value for the tentative evaluation value (step S450).

When the process at step S450 ends, if the calculated evaluation value is not smaller than the tentative evaluation value in the process at step S440 (step S440: No), or when the process at step S450 ends, control parameter adjuster 10 determines whether the termination condition for terminating the adjusting process is satisfied (step S460).

If it is determined in the process at step S460 that the termination condition for terminating the adjusting process is not satisfied (step S460: No), control parameter adjuster 10 sets a new value in each of the control parameters that driver 210 stores, based on optimization algorithm 11 that has been fed back with the evaluation values (step S470).

When the process at step S470 ends, the adjusting process returns to the process at step S420.

If it is determined in the process at step S460 that the termination condition for terminating the adjustment process is satisfied (step S460: Yes), control parameter adjuster 10 outputs each of the control parameters corresponding to the tentative evaluation values as each of the adjusted control parameters (step S480). Then, adjustment history storage 60 stores an adjustment history obtained when control parameter adjuster 10 has adjusted each of the control parameters of servomotor 220.

When the process at step S480 ends, control parameter adjustment device 100 terminates this instance of adjusting process.

Referring back to FIG. 6, the control parameter adjusting process will be further described.

When the adjusting process at step S400 ends, driver 210 obtains each of the adjusted control parameters output from control parameter adjuster 10. Driver 210 then overwrites each of the stored control parameters with each of the obtained adjusted control parameters (step S500). In other words, driver 210 updates each of the stored control parameters.

In response to driver 210 updating each of the stored control parameters, control parameter adjustment system 1 executes a storing process of storing, into database 300, an adjustment history obtained when control parameter adjuster 10 has adjusted each of the control parameters of servomotor 220 in the process at step S400 (step S600).

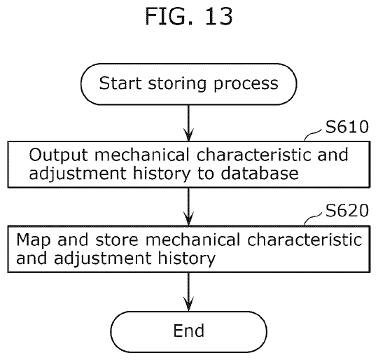

FIG. 13 is a flowchart of a storing process.

As shown in FIG. 13, upon the start of the storing process, outputter 80 outputs to database 300 the mechanical characteristic of apparatus 200 output from resonance frequency calculator 40 and the adjustment history stored in adjustment history storage 60, that is, the adjustment history obtained when control parameter adjuster 10 has adjusted each of the control parameters of servomotor 220 in the process at step S400 (step S610).

Then, database 300 stores the mechanical characteristic of apparatus 200 and the adjustment history obtained when control parameter adjuster 10 has adjusted each of the control parameters of servomotor 220 output from outputter 80 with the mechanical characteristic and the adjustment history mapped to each other (step S620).

When the process at step S620 ends, control parameter adjustment system 1 terminates this instance of storing process.

Referring back to FIG. 6, the control parameter adjusting process will be further described.

When the process at step S600 ends, control parameter adjustment system 1 terminates this instance of control parameter adjusting process.

### <Discussion >

As described above, control parameter adjustment device 100 configured as described above makes it possible to adjust each of the control parameters of servomotor 220 with the use of optimization algorithm 11 in which at least one of a search range or a search initial value of each of the control parameters of servomotor 220 is initially set appropriately.

Accordingly, control parameter adjustment device 100 configured as described above makes it possible for anyone who is not even a skilled technical expert to adjust control parameters appropriately.

### (Supplemental Remarks)

Thus far, some embodiments have been described to illustrate the techniques disclosed in the present application. The present disclosure, however, is not limited to the foregoing embodiments. Unless departing from the spirit of the present disclosure, an embodiment obtained by making various modifications that are conceivable by a person skilled in the art to the present embodiments or an embodiment obtained by combining the constituent elements in different embodiments or variations may also be encompassed by the scope of one or more aspects of the present disclosure.

General or specific embodiments of the present disclosure may be implemented in the form of a system, an apparatus, a method, an integrated circuit, a program, or a computer readable non-transitory recording medium, such as a CD-ROM. Furthermore, the general or specific aspects may be implemented through a desired combination of a system, an apparatus, a method, an integrated circuit, a program, and a non-transitory recording medium. For example, the present disclosure may be implemented in the form of a program that causes a computer device to execute the processes performed by the generation device.

### INDUSTRIAL APPLICABILITY

The present disclosure can be used widely in, for example but not limited to, apparatuses that adjust control parameters.

### REFERENCE SIGNS LIST

1 control parameter adjustment system
10 control parameter adjuster
11 optimization algorithm
20 initial setter
30 target setter
31 extractor
32 information calculator
33 calculator
34 presenter
35 input receiver
40 resonance frequency calculator
50 operation command outputter
60 adjustment history storage
71 first obtainer
72 second obtainer
73 third obtainer
80 outputter
90 interface
100 control parameter adjustment device
200 apparatus
210 driver
220 servomotor
230 sensor
300 database
400 network
501 graph
502 slide bar
503 control parameter information
504 automatic setting icon
511, 512, 513 line
514, 523 solid circle
521 first slide axis
522 second slide axis

1. A control parameter adjustment device that adjusts each of control parameters of an adjustment target servomotor included in an adjustment target apparatus, the control parameter adjustment device comprising:
a first obtainer that obtains an adjustment target mechanical characteristic of the adjustment target apparatus;
a second obtainer that obtains a plurality of mechanical characteristics and a plurality of adjustment histories respectively corresponding to a plurality of adjusted apparatuses each including an adjusted servomotor of which each of control parameters has been adjusted, the plurality of adjustment histories each being a history of adjusting each of the control parameters of the adjusted servomotor of a corresponding one of the adjusted apparatuses;
a control parameter adjuster that adjusts each of the control parameters of the adjustment target servomotor with use of an optimization algorithm in which at least one of a search range or a search initial value of each of the control parameters of the adjustment target servomotor is initially set, and outputs each of the control parameters adjusted; and
an initial setter that initially sets at least one of the search range or the search initial value of each of the control parameters of the adjustment target servomotor into the optimization algorithm, based on the adjustment target mechanical characteristic, the plurality of mechanical characteristics, and the plurality of adjustment histories.

2. The control parameter adjustment device according to claim 1, wherein
the initial setter initially sets, into the optimization algorithm, both the search range and the search initial value of each of the control parameters of the adjustment target servomotor, and
the control parameter adjuster adjusts each of the control parameters of the adjustment target servomotor with use of the optimization algorithm in which both the search range and the search initial value of each of the control parameters of the adjustment target servomotor are initially set.

3. The control parameter adjustment device according to claim 1, wherein
the adjustment target mechanical characteristic includes a resonance frequency of the adjustment target apparatus,
the plurality of mechanical characteristics each include a resonance frequency of a corresponding one of the plurality of adjusted apparatuses,
the control parameter adjustment device further comprises:
an operation command outputter that outputs, to a driver that controls the adjustment target servomotor, an operation command that causes the adjustment target servomotor to operate;
a third obtainer that obtains position information indicating a position of a driving target driven by the adjustment target servomotor that operates based on the operation command, by being controlled by the driver; and
a resonance frequency calculator that calculates a resonance frequency of the adjustment target apparatus based on the position information, and outputs the adjustment target mechanical characteristic that includes the resonance frequency calculated, and
the first obtainer obtains the adjustment target mechanical characteristic calculated by the resonance frequency calculator.

4. The control parameter adjustment device according to claim 3, further comprising:
an outputter that outputs, to a database, the adjustment target mechanical characteristic output from the resonance frequency calculator and an adjustment history of adjusting each of the control parameters of the adjustment target servomotor by the control parameter adjuster, wherein
the second obtainer obtains the plurality of mechanical characteristics and the plurality of adjustment histories from the database.

5. The control parameter adjustment device according to claim 1, further comprising:
a calculator that calculates at least one of the search range or the search initial value of each of the control parameters of the adjustment target servomotor, based on the adjustment target mechanical characteristic, the plurality of mechanical characteristics, and the plurality of adjustment histories, wherein
the initial setter initially sets, into the optimization algorithm, the at least one of the search range or the search initial value of each of the control parameters of the adjustment target servomotor, calculated by the calculator.

6. The control parameter adjustment device according to claim 5, wherein
when test control has been performed a plurality of times on the adjusted servomotor in a process of adjusting each of the control parameters of the adjusted servomotor, each of the plurality of adjustment histories includes, for each instance of the test control, (1) setting values of each of the control parameters of the adjusted servomotor and (2) evaluation values obtained by evaluating the test control,
the control parameter adjustment device further comprises:
an extractor that extracts, from the plurality of mechanical characteristics, a first mechanical characteristic similar to the adjustment target mechanical characteristic; and
an information calculator that, with regard to a first adjustment history, among the plurality of adjustment histories, of a first servomotor in a first adjusted apparatus having the first mechanical characteristic, calculates, for each of control parameters of the first servomotor, (1) the setting values, (2) setting frequency information pertaining to setting frequencies with which the setting values are set, and (3) evaluation value information pertaining to the evaluation values corresponding to the setting values, and
the calculator calculates at least one of the search range or the search initial value of each of the control parameters of the adjustment target servomotor, based on the setting values, the setting frequency information, and the evaluation value information calculated by the information calculator.

7. The control parameter adjustment device according to claim 1, further comprising:
a presenter that presents, to a user of the control parameter adjustment device, at least part of the adjustment target mechanical characteristic, the plurality of mechanical characteristics, and the plurality of adjustment histories; and
an input receiver that, after the presenting by the presenter, receives, from the user, input of at least one of the search range or the search initial value of each of the control parameters of the adjustment target servomotor, wherein
the initial setter initially sets, into the optimization algorithm, the at least one of the search range or the search initial value of each of the control parameters of the adjustment target servomotor, received by the input receiver.

8. The control parameter adjustment device according to claim 7, wherein
when test control has been performed a plurality of times on the adjusted servomotor in a process of adjusting each of the control parameters of the adjusted servomotor, each of the plurality of adjustment histories includes, for each instance of the test control, (1) setting values of each of the control parameters of the adjusted servomotor and (2) evaluation values obtained by evaluating the test control,
the control parameter adjustment device further comprises:
an extractor that extracts, from the plurality of mechanical characteristics, a first mechanical characteristic similar to the adjustment target mechanical characteristic; and
an information calculator that, with regard to a first adjustment history, among the plurality of adjustment histories, of a first servomotor in a first adjusted apparatus having the first mechanical characteristic, calculates, for each of control parameters of the first servomotor, (1) the setting values, (2) setting frequency information pertaining to setting frequencies with which the setting values are set, and (3) evaluation value information pertaining to the evaluation values corresponding to the setting values, and
the presenter presents the at least part to the user based on the setting values, the setting frequency information, and the evaluation value information calculated by the information calculator.

9. A control parameter adjustment method of adjusting each of control parameters of an adjustment target servomotor included in an adjustment target apparatus, the control parameter adjustment method comprising:
obtaining an adjustment target mechanical characteristic of the adjustment target apparatus;
obtaining a plurality of mechanical characteristics and a plurality of adjustment histories respectively corresponding to a plurality of adjusted apparatuses each including an adjusted servomotor of which each of control parameters has been adjusted, the plurality of adjustment histories each being a history of adjusting each of the control parameters of the adjusted servomotor of a corresponding one of the adjusted apparatuses;
adjusting each of the control parameters of the adjustment target servomotor with use of an optimization algorithm in which at least one of a search range or a search initial value of each of the control parameters of the adjustment target servomotor is initially set, and outputs each of the control parameters adjusted; and
setting at least one of the search range or the search initial value of each of the control parameters of the adjustment target servomotor into the optimization algorithm, based on the adjustment target mechanical characteristic, the plurality of mechanical characteristics, and the plurality of adjustment histories.
